(19) United States
(12) Patent Application Publication
(10) Pub. No.: US 2015/0332233 A1
(43) Pub. Date: Nov. 19, 2015

(54) APPARATUS, METHOD AND SYSTEM OF REPLACING PHYSICAL VERSIONS OF WORKS WITH ELECTRONIC VERSIONS

(71) Applicants: Matthew William Hurni, Saylorsburg, PA (US); Daniel Ryan Cooper, Philadelphia, PA (US)

(72) Inventors: Matthew William Hurni, Saylorsburg, PA (US); Daniel Ryan Cooper, Philadelphia, PA (US)

(21) Appl. No.: 14/058,100

(22) Filed: Oct. 18, 2013

(51) Int. Cl. G06Q 20/12; G06Q 50/18; G06Q 30/00; G06F 21/10; G06Q 30/06

(52) U.S. Cl. CPC G06Q 20/1235; G06F 21/10; G06Q 30/0609; G06Q 30/0603; G06Q 30/0185; G06Q 50/184

(57) ABSTRACT

Numerous methods of exchange are facilitated in which a physical copy of a previously-manufactured work embodying intellectual property in some tangible form, such as a physical book, are replaced with an electronic or digital version of similar intellectual property work, a replacement work or a derivative work. The physical item of manufacture is thereafter removed from the marketplace, or some aspect of its perceived private property value is diminished or destroyed physically or effectively so that physical items of tangible property are replaced by electronic or digital versions. To the extent first-sale doctrine under copyright law applies to physical or electronic versions of items, first-sale private property rights may be preserved for the benefit of the private property owner, even though the replacement electronic version of the work may be licensed, not sold, to the user through a disclosed mechanism of exchange.

### CROSS-REFERENCE TO RELATED APPLICATIONS

This application is related to, and claims the benefit of, Provisional Application No. 61/715,388, filed on Oct. 18, 2012, and entitled “Method of Replacing Physical Versions of Works with Electronic Versions.” The foregoing application is herein incorporated by reference in its entirety.

### REFERENCES CITED

### U.S. Patent Documents

WO2006081482A2
WO2009143606A1
WO2012174171 A2
CN101023437A
CN101023437B
CN101681399A
CN102118655A
CN1021186558
CN102918557A
CN1185217A
CN1203679A
CN1650559A
CN1650559B
CN1989521A
EP2302553A2
EP2302553A3
EP2341460A1
US20010056463
US20020062252
US20020082922
US20020156740
US20020184189
US20030023561
US20030076955
US20030093382
US20040049482
US20040103025
US20040234935
US20050125355
US20050258638
US20060010075
US20060168507
US20060212435
US20070005616
US20070026371
US20070106794
US20070226321
US20070241196
US20070244768
US20080010076
US20080313741
US20080319867
US20090026255
US20100306035
US20110040975
US20110161205
US20110162086
US20110166949
US20110320258
US20120127639
US20130066464
US20130073468
US20130191708
U.S. Pat. No. 2,324,413
U.S. Pat. No. 5,754,648
U.S. Pat. No. 5,754,649
U.S. Pat. No. 5,761,485
U.S. Pat. No. 6,331,865
U.S. Pat. No. 6,496,802
U.S. Pat. No. 6,609,105
U.S. Pat. No. 6,961,905
U.S. Pat. No. 6,996,364
U.S. Pat. No. 7,020,663
U.S. Pat. No. 7,117,523
U.S. Pat. No. 7,149,353
U.S. Pat. No. 7,174,054
U.S. Pat. No. 7,376,581
U.S. Pat. No. 7,487,363
U.S. Pat. No. 7,487,914
U.S. Pat. No. 7,542,625
U.S. Pat. No. 7,805,374
U.S. Pat. No. 7,844,821
U.S. Pat. No. 8,104,671
U.S. Pat. No. 8,112,363
U.S. Pat. No. 8,150,864
U.S. Pat. No. 8,364,595
U.S. Pat. No. 8,464,929
U.S. Pat. No. 8,484,089
U.S. Pat. No. 8,521,611

### BACKGROUND

There are increasingly two separate and distinct, though related, retail industries and marketplaces for physical items of manufacture which embody copies of intellectual property or various works derived therefrom. In the conventional retail industry, items of physical manufacture satisfy the conventional demand for the exclusive private property ownership right to possess or dispose of copies, a property right which is well-established in legal precedent governing so-called “copyright industry” policies and procedures pursuant to the “first-sale doctrine” of copyright law.

In summary, the owner of a first-sale property right can resell any item of physical property lawfully to a third-party, without further consent from the holder of the copyright or the manufacturer, because the owner purchased that right when they paid to acquire, were granted, earned, inherited, or otherwise became the lawful physical holder of such a copy previously manufactured. Because of “first-sale doctrine” there is a substantial economic value inherent to conventional pre-owned physical merchandise, such as physical books, even though these items contain copyright-protected intellectual property of which electronic copies are also available.

Another retail industry and marketplace also exists for copyright-protected intellectual property and the various works derived from intellectual property: the digital media industry and electronic marketplace. Whereas private property rights acquired through the “first-sale doctrine” in the case of physical items, such as physical books, follow the physical item of merchandise and those items are sometimes said to have been imbued with that property right at the time of manufacture by virtue of the express consent of the intellectual property right holder who exercised the right to manufacture said items, there is not presently any corollary with electronic or digital merchandise, such as electronic books or the digital media containing a derivative of the intellectual property which forms such an item when that digital information is downloaded or installed into a device such as a computer or an electronic book reader device. Today it is the standard of practice in this new retail industry and marketplace to merely license copies of the work to users of the technology, but to reserve the right to prohibit resales thereof to any unauthorized third-parties. This inherent limitation of property rights, in the absence of a standard of practice or legal precedent that would be the equivalent of a “first-sale doctrine” for the digital media industry and that would govern the economic activities of customers, electronic or digital retailers, and intellectual property rights-holders, creates a very real uncertainty about the present and future value or control of electronic copies and digital works. Much of the prior art attempts to address this uncertainty.

To the extent that a physical item exists which is imbued with the property rights acquired or licensed from right-holders whose intellectual property derivative works may be present within the data storage within the physical item, the standard of practice today in electronic or digital media retailing is for the physical items of manufacture, such as electronic book readers, to be sold and resold separate from any electronic copies and digital works that these devices have the potential to contain or display. Current business practices and the limited reach of legal precedents in case law make it a legally-ambiguous area of the present electronic marketplace whenever a customer/licensee who has paid to license and receive electronic copies and digital media works in downloaded or digitally-installed form, for their own private use, transfers the content of such a device when the device itself is resold to a third-party.

Both the conventional retail industries and marketplaces for physical items of manufacture which embody copies of intellectual property or various works derived therefrom, and the new electronic or digital media industries and marketplaces, have attempted to perfect commercially-significant solutions to the intrinsic economic challenges that have been created by changes in consumer behavior around all intellectual property-based industries, and as consumers have demonstrated a preference for technology that appears to remove nearly all private property rights, privacy while enjoying possession of a copy, or civil freedoms to otherwise use the intellectual property works for private non-commercial purposes with no further consent of the intellectual property rights-holder or manufacturer, from the consumers. There have not, to date, been many commercially-significant innovations in this respect, due in part to lack of consumer demand but also due to lack of systems and methods that satisfy these rights-holders. The same principles apply to items of manufacture or electronic or digital media replacements thereof where the physical items and the replacement items may be protected by patent or trademark rights. It has become increasingly-difficult in recent years for patent- and trademark-rights industries to manage their industries or the retail marketplaces from which they often derive much of their economic value.

An innovation that can provide commercially-significant solutions to these new challenges would be of particular economic value. The prior art is full of failed attempts and good ideas that could not achieve market acceptance because they lacked the right mix of value-creation and value-protection for parties involved in the creation, manufacture, distribution, and resale of intellectual property-derived works.

The Amazon.com Kindle MatchBook is an example of a method or system in which a user is provided with access to the electronic version of the physical work after it is first determined that the user owns the physical work. To illustrate just one reason why book publishers have not embraced the new Kindle MatchBook innovation with particular enthusiasm, there is no way for Amazon.com to determine that a particular customer who purchased a particular physical work in the past still owns the exclusive right of resale conferred upon the owner by the “first-sale doctrine” at the time of the original book purchase. For publishers to be asked to presume that nobody who buys physical books through Amazon.com ever resells the books to a third-party, lends them to friends, or gives them away as gifts, is nonsensical. The exact opposite must be presumed: that the publisher is, at all times, in direct competition with everyone who previously purchased a physical work when new buyers are sought for new first-sale or new resale transactions. The Kindle MatchBook solution creates untenable marketplace dynamics for publishers, and poses significant problems for other participants in both the conventional retail industries and in electronic or digital media replacement industries consisting of intellectual property-derived products.

U.S. Pat. No. 7,542,625 teaches methods and systems whereby a user may be provided access to an electronic version of a physical work based on ownership of the physical work, including where the user proves ownership of a physical work (and thereby the user proves they have rights conferred in accordance with the “first-sale doctrine”) in a number of ways such as where a user “may provide an image of a portion of the physical work to confirm ownership of the work” followed by “permit user access to an electronic version of the entire physical work when ownership of the work is confirmed.” In more detail, U.S. Pat. No. 7,542,625 teaches that “if ownership of the book cannot be confirmed by reference to a purchase record or other data source for validation of ownership” then “additional steps to validate ownership” may be required. For example, “copies of receipts evidencing purchase” or the user may “provide an image of one or more pages from the selected book to validate ownership” are additional methods taught. However, these teachings do not in fact help to “confirm” nor “validate” any such “ownership” because, in the case of physical books or other physical items of merchandise, the owner receives the automatic right pursuant to the “first-sale doctrine” to resell or otherwise to dispose of the right of private property “ownership” referenced by the '625 patent and purportedly “confirmed” or “validated” in accordance therewith. In practice these methods do not confirm ownership as claimed.

U.S. Pat. No. 2,324,413 teaches the importance of technology and methods to increase the number and variety of sales transactions achievable in practice from intellectual property-derived products such as printed books. By introducing a form of self-destructing book or magazine, certain problems associated with long-lived literature can be better managed by publishers or distribution and resale marketplace. In circumstances and in consumer markets where lower-cost shorter-lived product is desired, ensuring that first-sale property rights cannot last indefinitely or do not easily result in resales or patterns of use that undermine the premium commercial value of newly-purchased copies of product are clearly beneficial.

U.S. patent application Ser. No. 10/852,414 discloses another method of reducing a book's resale value by physically destroying parts of the book in the normal course of use by the consumer. The invention described in the '414 patent suggests that consumers would find it rewarding to accept the partial destruction of the product, such as because removing part of the cover would allow the removed portion of a book cover to be mailed to the publisher to enter a drawing or sweepstakes. Like the '413 patent taught before it, adding pre-planned destruction of the physical item of literature primarily for benefit of the publisher is at odds with the desire of most consumers who expect product they own to be available to them at-will.

U.S. Pat. No. 7,805,374 teaches the valuable benefits of a digital media inventory control, distribution and destruction system, apparatus, or article of manufacture. Many retail stores that sell intellectual property-derived products benefit from a ready-made system and method for the “destruction of digital media, such as music, movies, video games, computer software” and other digital media products that are commonly sold in the form of physical items such as Compact Discs (CDs) or Digital Versatile Discs (DVDs) when the same solution is used to allow on-demand distributed manufacturing. Avoiding conventional centralized product manufacturing or inventory shipping and receiving offers economic advantages that benefit publishers as well as retailers. Although on-demand in-store manufacturing may also add extra value for consumers, the '374 patent does not teach any particular value to consumers of the facility for on-demand item destruction. This omission leaves the lifecycle of ownership incomplete especially in terms of being able to provide consumers with extra options or models of value-discovery.

For these and other reasons, intellectual property-derived industries and marketplaces of a conventional physical form or of new electronic or digital media form continue to experience fundamental economic problems and disagreements of methodology and technical system design or function. To the extent that the prior art has failed to introduce a commercially-significant solution to some aspect of these ongoing problems, new innovations are still required and there is a window of opportunity for those that are particularly well-conceived to grow substantially valuable and important in future commerce involving an exchange of physical items for electronic or digital substitute items.

It is an objective of this invention to enable paying for such item exchanges.

### BRIEF SUMMARY

This brief summary presents a synopsis of the invention disclosures contained herein, the objectives of which are varied and may be especially innovative and useful for select embodiments. This summary does not identify every feature or embodiment of interest to one skilled in the art of methods or systems of operating intellectual property-based marketplaces who may seek insight or guidance into aspects of technical or commercial value in the present invention. This summary is not meant to define nor should it be read to limit the full scope of the various embodiments implied or disclosed and claimed hereafter.

A marketplace consisting of customers who buy physical items of manufacture from retailers where the physical items are derived from intellectual property that is able to be embodied in a digital format that can be transmitted, downloaded, installed or copied intangibly such as through the use of a computer or other electronic device, contains inherent risks and inefficiencies to consumers, producers or retailers in the absence of an innovation that is able to monitor and preserve supply/demand balance, and to protect all private property rights of each participant in the marketplace. In one aspect of the invention, owners of physical items, such as physical books, may discover through a means of advertising communication in the marketplace, that physical items they own can be surrendered to a third-party such as a retailer in order to exchange the physical items for replacement electronic or digital media products such as ‘new’ electronic books of the same, similar, or unrelated subject matter from the same or unrelated publishers. The method may physically remove supply from the marketplace by destroying the physical items with substitute ownership or license rights being granted to the surrendering owners potentially after owners pay fees associated with the conversion of the previous ownership rights into newly-created licenses to or electronic ownership rights in, as the case may be, electronic or digital media replacement products.

The method enables verification of authenticity of the physical items that are supplied by owners in any exchanges of physical items for electronic or digital media replacement products. Further, correlations are possible between historical purchase receipts reflecting past purchases and future exchanges of the physical items for electronic or digital media replacement products, where sufficient purchase history is available to the system at the point of sale or point of exchange. Achieving correlation as a prerequisite to replacement transactions improves marketplace function by memorializing end-of-life transactions that extinguish individual participants' ownership rights previously acquired through purchases of new or used physical items first manufactured and sold under the authentic and exclusive authority of the intellectual property rights-holder. Uncorrelated exchanges are less-desired in certain embodiments due to the common industry practice of persistently-coupling purchase receipt information to on-demand access to online services, streaming media or transient and temporal interactive digital communications systems through which owners may be given access to a centralized repository of intellectual property or products derived from intellectual property purchased in manufactured physical item form. When the original purchases are later correlated with exchanges of physical items into electronic or digital media replacements, duplicative ownership rights and phantom or residual ownership records can be avoided or minimized such as where items are purchased as gifts and the gift-recipient performs an uncorrelated exchange that leaves an erroneous record of continued physical ownership in the name of the first-sale buyer. Erroneous business records can be reduced or eliminated through the invention disclosed herein that exchanges and optionally destroys used physical items and updates owners' prior purchase records.

Another embodiment of the invention involves a computer system, mobile phone, touch-screen tablet device, or a similar data processing apparatus that contains a data communications means and a means of receiving mobile programming instructions from a server. The server communicates with the data processing apparatus through the data communications means and thereby delivers new programming instructions, such as a mobile App, a software program, or a script that the data processing means is able to interpret or execute, or data that the data processing means is able to process, such as by using an embedded microprocessor, which optionally provides a user interface means with the capability of responding to user gestures, touch input or voice command input, and the capability also of displaying information to a user, whereby the programming instructions are, when loaded into the data processing apparatus and/or processed, interpreted or executed therein, useful for illustration, display, simulation or producing an audible communication that is perceived by a user of the data processing apparatus to demonstrate or teach how the user can accomplish safe and effective destruction of the physical item of merchandise that contains intellectual property that the same or another user of the system would like to replace with an electronic or digital media version thereof, or replace with a substitute therefor. After the step of destroying the physical item is accomplished, a user of the system may be provided with a replacement electronic or digital media version of the product derived from the intellectual property. In another embodiment, a user of the system may be provided with a substitute electronic or digital media product derived from different intellectual property from that which was contained in the physical item.

Some embodiments will preferably achieve the delivery of the replacement electronic or digital media item after verification of authenticity of the physical item and/or confirmation of the ownership thereof by the user is first accomplished in accordance with the methods and using the system disclosed herein, so as to avoid the undesired outcome in which a user may be provided with a replacement electronic or digital media product without first being in possession of, and/or holding an ownership right to, some physical item of merchandise that can be surrendered, recycled or destroyed by the user as a step in the use of the system. The system may, in certain embodiments such as a self-service retail kiosk, hold the physical items in a secure storage compartment while verification of authenticity of the physical items and/or confirmation of the ownership thereof by the user is first accomplished. The user may receive and verify that the electronic or digital media replacement or substitute items are satisfactory, and only after such acceptance by the user of the replacement or substitute items may the user's physical items be destroyed within the secure storage compartment. In some embodiments the physical items may be recycled or returned to a retailer, manufacturer, rights-holder, or to a third-party after the exchange.

In another embodiment, a user may be provided access to an electronic or digital media version of a physical item based on the user's ownership of the physical item. The method of receiving physical possession of the physical item from the user, together with an ownership verification step whereby a past purchase record is reviewed and confirmed for authenticity especially by comparing the SKU or other physical item identifier indicated in the purchase record against the known SKU or other physical item identifier associated with the item surrendered by the user to confirm that the item supplied by the user is of exactly the same type and variety as the item previously purchased by that same user, ensures that a one-for-one correlation can be preserved to avoid granting access to electronic or digital media versions of physical items unless the physical item is first surrendered. In certain embodiments, there may be a temporary access privilege granted to the user, and the physical item may be held temporarily by a third-party, such as at a library, while the temporary access privilege permits the user to download, install, view, listen to, read, play, execute, or otherwise use the electronic or digital media item derived from intellectual property until such time as the physical item is retrieved by the user or until the access privilege otherwise expires. In this embodiment, correlation between physical item ownership and user access to a replacement electronic or digital media version of the physical item is preserved by escrow.

In another aspect, a computer implemented method is provided in which a user request for access to or possession of an electronic version of a physical item is processed. Electronic or digital media versions of physical items are stored in a data storage device such as a magnetic or optical storage device. The electronic or digital media versions of the physical items may be creative works protected by copyright, and, if the works are visual works, comprise data stored which is used to form an image or images of the works that, when visually displayed to the user such as on a computer display, appear visually to be the same as the physical item, such as when compared word-for-word or photograph-for-photograph in books comprised only of words or photographs, or in a combination of the two. Likewise, electronic or digital media versions of the creative works, if the works include audio or are strictly audio, comprise data stored which is used to form a version of sounds produced by the creative works such as through use of a selected coder/decoder (“codec”) algorithm useful for reproducing recorded digital audio. In many instances, an electronic or digital media version of a creative work or other physical item that is derived from intellectual property and that can be embodied in electronic or digital media form, will have enhancements such as animated computer graphics or other display features that alter the form of presentation and/or the consumer user interface experience when compared to viewing or enjoying the physical item derived from the same creative work or intellectual property.

In some cases the title of the physical item of manufacture will exactly match the title of an electronic or digital media version while in other cases the title will not match despite the common shared origin from the same creative work or intellectual property. One beneficial feature of temporary access to the replacement electronic or digital media version of the physical item is that the user can decide whether the replacement product satisfies their requirement for form or function of presentation and content when compared to the physical item. As a result of employing the steps of authenticity confirmation, ownership verification and temporary escrow, as in the case of a library, or secure storage, as in the case of a self-service kiosk, the quantity of first-sale property rights is meaningfully-constrained for the benefit of manufacturers and retailers, while also providing new and valuable product and service offerings that transform ownership of an item of merchandise into a perpetual material economic relationship with any marketplace participant who will offer value in exchange for users' surrender of their limited supply of first-sale property rights.

### BRIEF DESCRIPTION OF THE DRAWINGS

The range of potential embodiments of the present invention and the advantages thereof will be better illustrated by reference to the following detailed description, together with the following drawings. Use of the same reference numbers in multiple figures reflects similar components of the system or method.

FIG. 1 is a self-service e-book exchange kiosk for physical book, magazine or other printed literature to be provided for potential exchange in the form of replacement digital media or electronic book product.

FIG. 2 is a schematic diagram depicting communications channels between the components of a system in which physical book, magazine or other printed literature is provided by users via self-service kiosk for the potential exchange into a form of replacement digital media or electronic book product.

FIG. 3 is a schematic diagram depicting communications channels between the components of a system in which a user physically destroys or recycles a physical book, magazine, or other printed literature item by providing it to an apparatus that is connected to, and/or in communication with, a computer.

FIG. 4 is a schematic diagram showing a method of postal mail delivery of used books, magazines or other printed literature by way of postal mail where a step in the method uses Internet communication.

FIG. 5 is a flow diagram of the sequence of events in authenticity verification, ownership verification, user purchase history analysis, delivery of digital media or electronic product, and physical recycling of physical items provided by users of the invention for replacement digital media or electronic products.

FIG. 6 is a schematic diagram depicting one embodiment of the invention in which a first, preferably old and out-of-date, electronic physical item containing intellectual property such as data, software, or audiovisual digital media, can be physically received and substituted with a replacement device and/or upgraded or replaced with a new version or with substitute digital media, and then recycled or removed from use in the market in its previous form, which form may have been as a used item of merchandise.

### DETAILED DESCRIPTION

Whereas the present invention may take many forms and may be implemented in various embodiments, shown in above-referenced drawings or described further herein are various preferred embodiments of the invention that should be understood to exemplify principles of the invention, not to limit its scope.

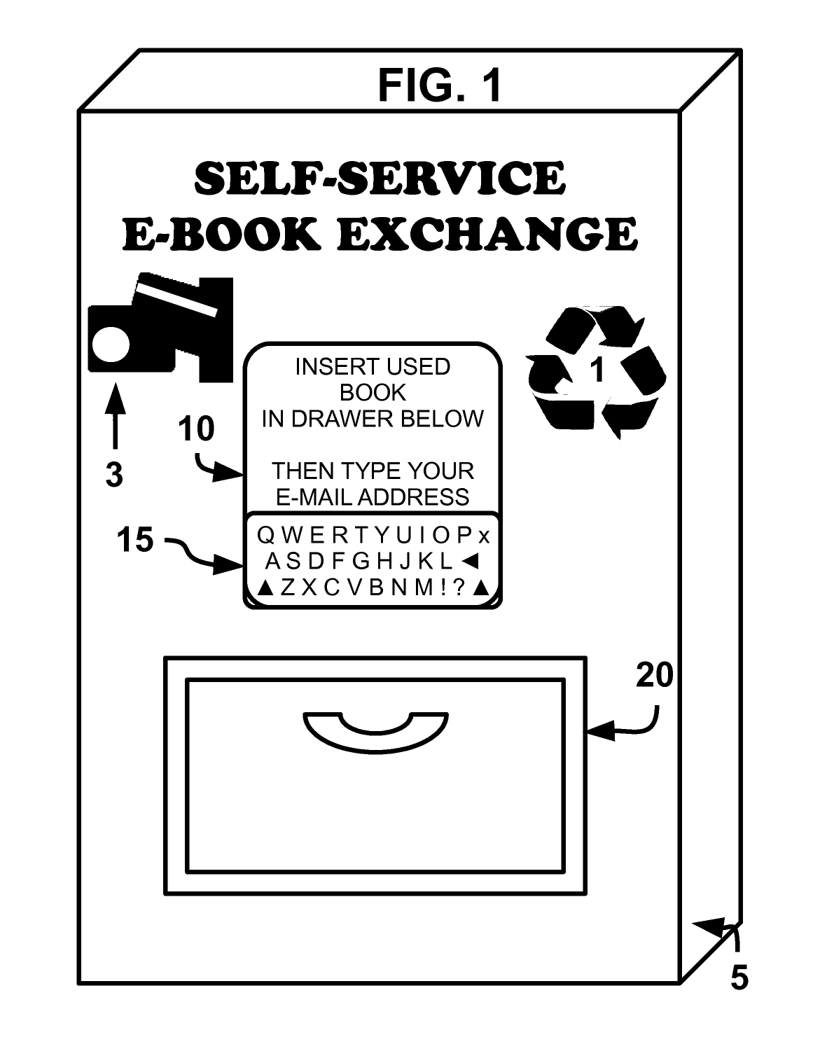

FIG. 1 illustrates a self-service Kiosk 5 where a physical book can be exchanged for an electronic or digital media e-book. The Kiosk 5 is used to accomplish a recycling process in recycler 1 thus causing the physical item to be removed from the marketplace of pre-owned physical items to remove copies of intellectual property previously-sold and used in the form of physical items manufactured by, or manufactured on behalf of, an intellectual property rights holder. Removing from the marketplace some percentage of all pre-owned copies of intellectual property, which can be embedded or contained within many physical items of manufacture, not just printed books or other literature, including in electronic devices that are designed to display intellectual property such as by using an integrated Liquid Crystal Display (LCD) screen and a keyboard or touch-screen user interface device, is beneficial to producers and consumers of products that contain intellectual property by, among other things, replacing old and out-of-date information, media, knowledge, or ideas with more up-to-date and valuable replacements.

To the extent that a more economical supply of up-to-date intellectual property products can be assured by decreasing the number of copies of products that may be borrowed, shared, or re-sold to others such that each person buys their own copy, uses it for a limited period of time when it has the most value, and then has a mechanism of recycling available to them through which they can recover some of the financial investment that was made in their prior purchases, the entire marketplace can be made more efficient and economical with less out-of-date products circulating to the detriment of both the vendors of new products and consumers who would prefer to buy up-to-date products rather than old used ones. In the design of the Kiosk 5 there are numerous ways for recycler 1 to be implemented, the details of which depend on the type of physical items that will be recycled, repurposed, prepared for re-use, or otherwise removed from circulation in the marketplace for pre-owned merchandise. In a preferred embodiment, the recycler 1 is an end-result of the use of the invention, one of its objectives, and the embodiment of recycler 1 in a given Kiosk 5 might be as simple as a temporary storage compartment analogous to a recycle bin wherein the received physical items may be stored until they are collected later for transport to a recycling center. In another preferred embodiment, the physical items received by the Kiosk 5 are physically disassembled and the raw materials are prepared, such as chemically, for a further step of processing for reuse or recycling, such as in the case of a chemical solution in which paper might be soaked over time to begin to remove and optionally recover ink or other substances that were deposited thereon during manufacturing. Kiosk 5 can advantageously be constructed in a location in close proximity to or in physical connection to such a paper recycling pre-treatment liquid reservoir. One of the objectives of the present invention is to minimize the amount of human effort and financial investment required in order to accomplish the final recycling or re-use step that becomes possible by virtue of guiding owners or those in possession of physical items of manufacture, who may or may not be owners by virtue of possession, to a process and a location in the marketplace where first-sale rights attributable to the first purchase or first transfer of private property from a manufacturer or a retailer to the first private owner thereof who is typically referred to as a consumer or the first-sale retail buyer.

Another preferred embodiment involves a mechanism of altering the physical item, so that the physical item together with the intellectual property contained therein cannot be resold or transferred to another owner without the further consent of the intellectual property rights holder. Alteration may be achieved in recycler 1 by, for instance, overwriting a data storage medium contained within the physical item with pseudo-random data in a way that is well-known in the prior art. This makes it difficult or entirely impossible for the original data to be recovered and only an intellectual property rights holder can grant permission for a new copy of the previously-stored data to be re-written onto the storage medium in place of the pseudo-random data. Such alteration renders physical items re-usable and less marketable.

Inside Kiosk 5 is a secure storage compartment 20 that is readily accessible to the user of the Kiosk and into which the user can physically insert a physical item that they wish to exchange for an electronic or digital media replacement, version, or substitute therefor. After the user physically inserts a physical item into compartment 20 the user will interact with a user interface 15 to provide responses prompted by a display screen 10 or similar instruction panel. Display screen 10 is preferably an LCD screen that is computer-controlled in the manner well-known in the prior art, so that screen 10 is able to show the user visible output corresponding to and in response to the keystroke input received from the user by way of user interface 15 in addition to providing the user with usage instructions or other information.

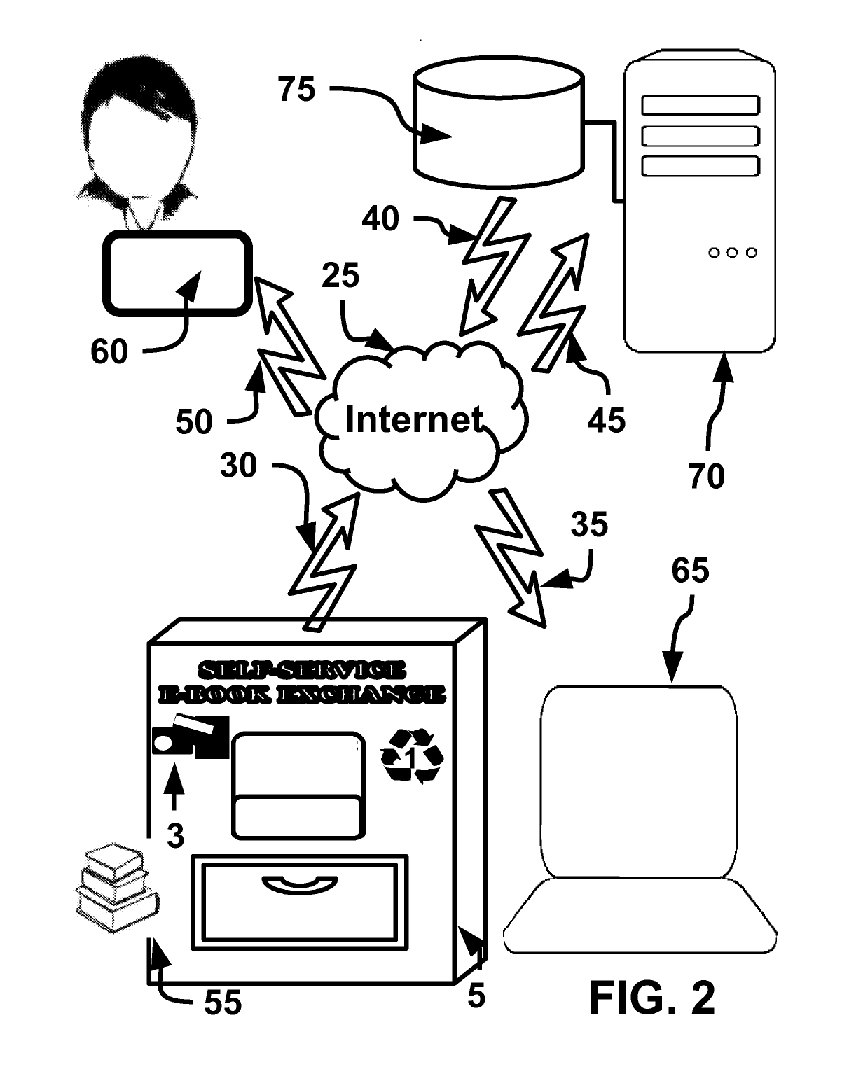

In some embodiments of the present invention, Kiosk 5 is entirely self-contained except for electricity which may be provided by a connection to a utility grid. In other embodiments Kiosk 5 is dependent on communications means that enable cooperating devices, such as computer servers and databases, to be included in the process of making decisions, displaying reports, receiving information, searching for information, and making new business records inside or outside of the Kiosk 5. Particularly important in many embodiments are the additional communications means and pathways depicted in FIG. 2.

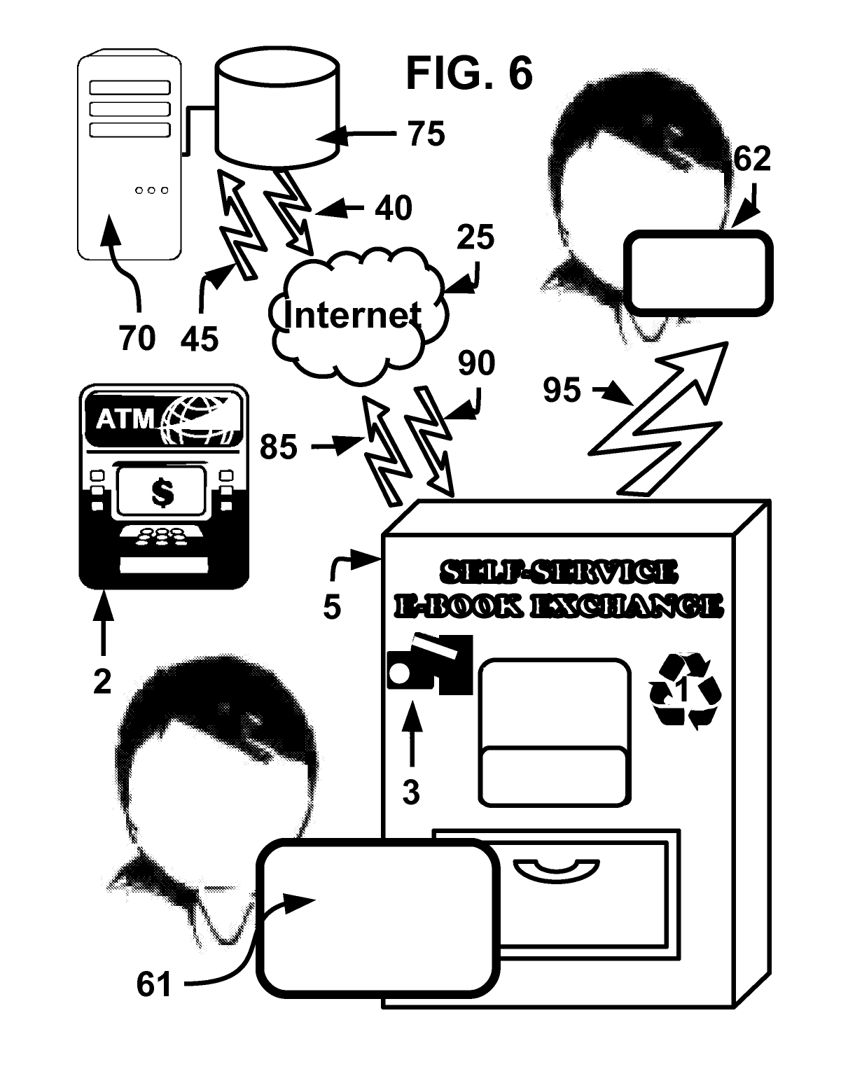

When physical item 55 is physically received from a user of the invention, such as into Kiosk 5, means of communication 30 is employed by Kiosk 5 to send information about the user, such as the e-mail address of the user, and to send information about the physical item that was physically received. In most embodiments, whether a Kiosk 5 is present to enable a self-service mode of operation or not, the information collected from the user will include some form of payment information such as a payment card inserted into payment card reader 3 (as shown in FIG. 1), a point of sale terminal or ATM machine 2 (as shown in FIG. 6), or, in a preferred embodiment an authorization instruction that allows a fee to be charged to the user's account with the operator of the invention or with a third-party such as an Internet payment services provider (e.g. PayPal) who can process payments using only an e-mail address (or other form of account name or number) or with a wireless carrier such as to permit adding a charge to the monthly bill associated with the account holder's wireless telephone service. Any method of payment processing or funds transfer, as well as any method of conveying or receiving a property right or other exchange of value that may be acceptable to the operator of the invention as a form of payment can be employed. In Kiosk 5 embodiments there is preferably also a payment card magnetic stripe reader 3.

Means of communication 30 optionally has or preferred embodiments have a means of communication that transmits data over the Internet 25 but any means of communication 30 that results in means of communication 45 being employed to send information to computer server 70 so that information can be stored in database 75 will suffice. The same or different database 75 and the same or different server 70 can be used to search for and, by way of means of communication 40, information of value to the user or of use in the processes, steps or components of the invention can be transmitted thereto. In some preferred embodiments means of communication 50 and 35 will be used to deliver information and/or the replacement electronic or digital media product to compute device 60 or 65, respectively, as shown in FIG. 2.

It should be apparent to those of skill in the art that means of communication 30 and means of communication 45 can optionally be one and the same, whether or not Internet 25 is included in the communication pathway using mechanisms that are well-known in the prior art.

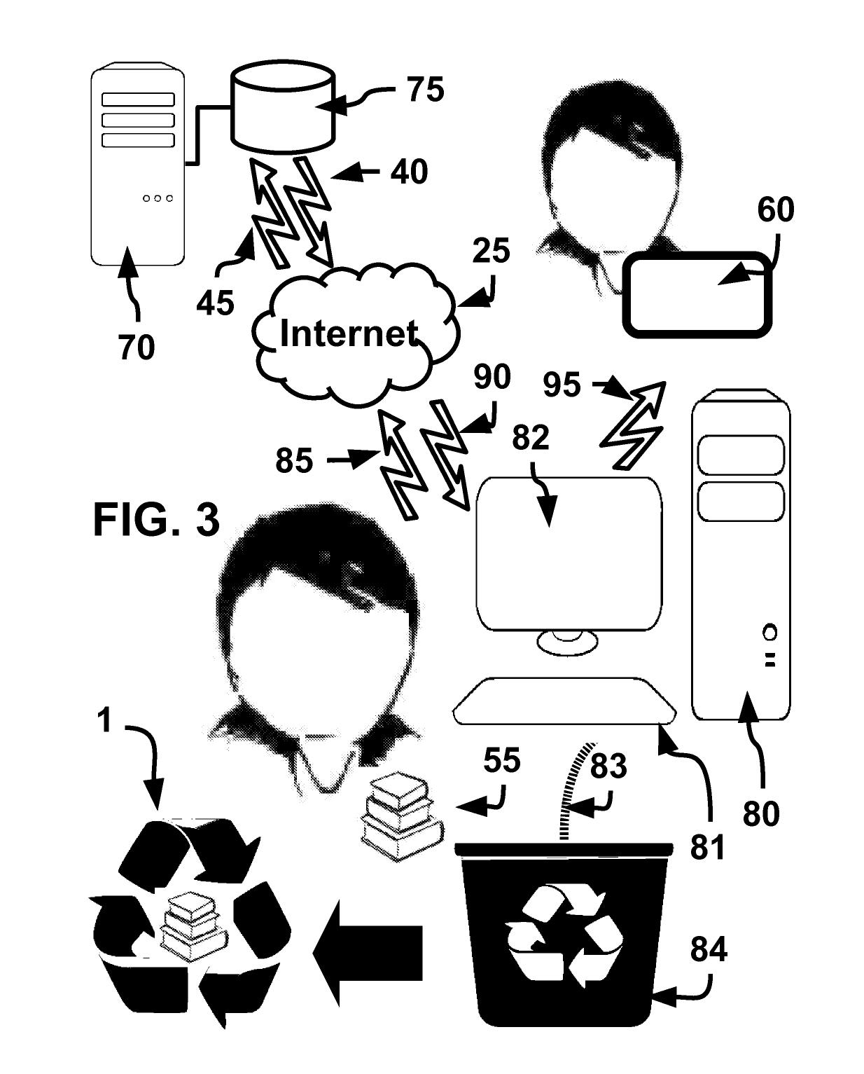

FIG. 3 depicts an embodiment of the invention in which a personal computer 80 is connected to a keyboard 81 and a computer display 82 for the purpose of controlling, through a connector cable 83, an apparatus 84 that facilitates verifying the authenticity of a physical item and physically receiving the physical item so that the item can be exchanged for an electronic or digital media version of the item.

In an embodiment depicted in FIG. 3 there is a means of communication 85 used to send information via the Internet 25 and means of communication 45 to computer server 70 to store data in database 75. The same, or a second computer server, and the same, or a second database, communicates via the Internet and a means of communication 40 and means of communication 90 so as to assist with the verification of authenticity of the physical item 55 received from the user via apparatus 84. Payment information can be transmitted to the computer server 70, or a second or third computer server, so as to charge a fee. In a preferred embodiment of the invention, these means of communication with computer servers located on the Internet or accessible via another computer network can be used to search for a prior purchase record associating the physical item 55 with the user of the invention who is identified through standard identification means including but not limited to a user account password, payment card inserted into payment card reader 3, or a wireless device such as a mobile phone which may help to identify the user in a number of ways such as by facilitating receipt of a verifiable Short Message Service (SMS) message that is sent to the user after the user provides their mobile phone number to associate the number with their account. One of skill in the art will recognize that payment card details could be typed in by the customer rather than relying on physical insertion into a magnetic card reader 3.

The end result of the system depicted in FIG. 3 is the removal of the physical item received by way of the system from the marketplace and preferably recycling of the physical item to reduce pollution of the natural environment from discarded used items of merchandise. Another end result objective of the present invention is to enable electronic device 60 to receive, from the Internet or other means of communication (or in some embodiments received from personal computer 80 by way of means of communication 95), the delivery of the replacement or substitute electronic or digital media item.

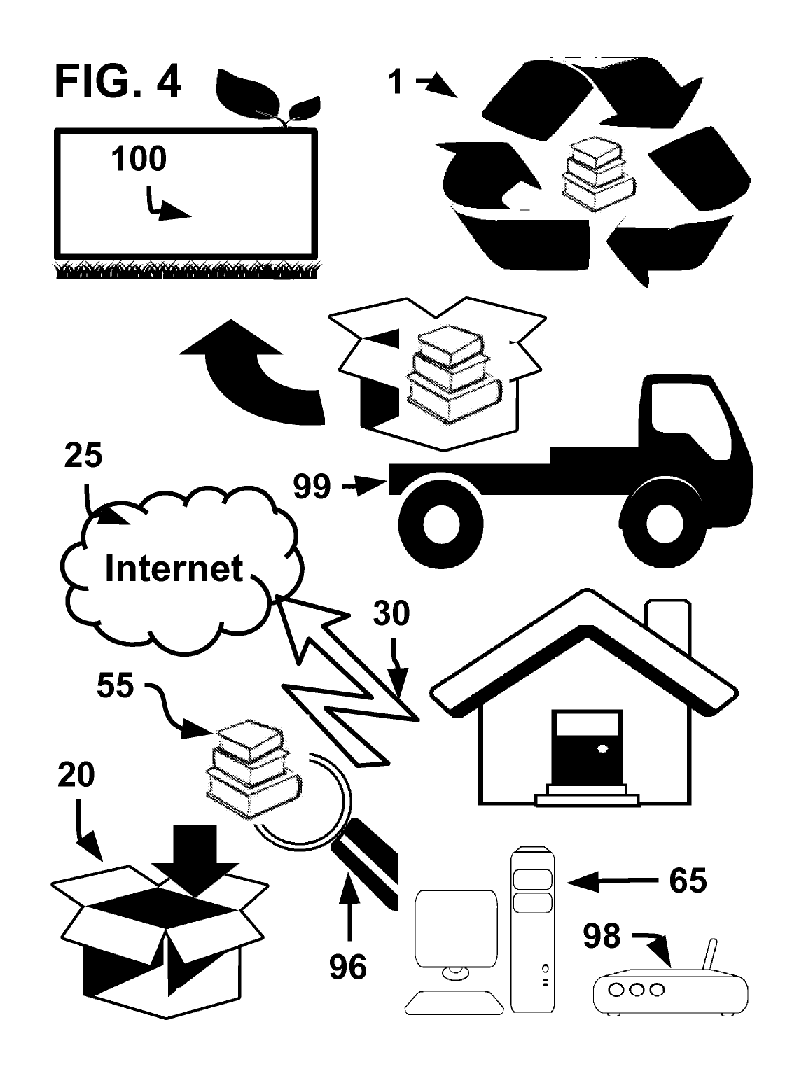

FIG. 4 shows a typical in-home consumer self-verification embodiment of the invention, wherein authenticity verification tool 96 is used by the owner or the provider of a physical item 55 to examine physical item 55 for verification of authenticity. Any method of counterfeit detection suitable to definitively detect obvious counterfeit items can be used as known in the prior art. Verification tool 96 is preferably designed to be able to use available means of communication 30 to send data regarding the physical item 55 via the Internet 25 to a computer server (not depicted) similar to computer server 70 where database 75 can store information about the user, the physical item 55, and the result of the examination of physical item 55 for future use. It is preferable that verification tool 96 also be able to receive information from the computer server (not depicted) to receive, for instance, search results after a further counterfeit detection process performed by the computer server. However, in most preferred embodiments of the invention it is an objective and intent of the invention to help remove counterfeit items from the marketplace, therefore it is optional to alert the user that the authenticity verification process failed or to warn of counterfeit items detected by the examination carried out with verification tool 96. In-home, self-verification embodiments of the invention require a computer 65 and a home-based computer network access point 98 to create means of communication 30 and thereby access to Internet 25. In order to provide an in-home secure storage compartment 20 a shipping container such as a cardboard box may be utilized. Storage compartment 20 can be provided securely to a third-party such as a shipping and delivery courier 99 or postal mail carrier 99. A recycler 1 is expected to be located, in such embodiments, in an industrial recycling facility 100.

Authenticity verification tool 96 is preferably designed to verify, within the privacy of the user's home, whether the physical item 55 is obviously counterfeit, but it is not necessary for verification tool 96 to be capable of ruling out all counterfeit items. One well-known method of detecting obvious counterfeit physical items involves a search for a watermark or a potentially-concealed numeric code that is expected to be located in a certain place as deposited there during the manufacturing of the item by an authorized manufacturer. Verification tool 96 may simply guide the in-home user of the invention to position the tool in a particular location on the physical item 55 so that a photograph of the surface of the physical item in the particular location can be transmitted digitally via means of communication 30. Together with transmitting a photograph of the “plan view” (the view of the physical item 55 from overhead looking straight down at it) or some “elevation view” (a view of the physical item 55 at “eye level” looking from an end or a side) of the physical item 55 showing the entirety of the outer dimensions or three-dimensional quality thereof, the user can, perhaps with the help of verification tool 96, definitively demonstrate, affirm and verify that they are in possession of a particular physical item 55 and the information required to ascertain whether it is obviously a counterfeit item can be transmitted. With this information, compute device 65 or a similar compute device 60 or 80 as depicted in FIG. 3 can be provided with an electronic or digital media replacement or substitute item, possibly prior to physically receiving the physical item 55 with the help of a delivery courier 99. By collecting information about the identity of the provider of the physical item 55 including, for example, the IP address and physical address from which the delivery courier 99 reports receiving the storage compartment 20 (e.g. a cardboard box with shipping label affixed), it is possible for the present invention to enable a company and the company's customers to operate at the speed of trust by presuming that the customer is acting in good faith and has truly packaged the physical item 55 and that the customer has in fact arranged with a delivery courier 99 for the company to physically receive the physical item 55 in the future. It will be understood by one of skill in the art that in a circumstance where the verification tool 96 detects a counterfeit physical item 55 there may nevertheless be a desire on the part of the company that uses the invention to extend an offer of substitute or replacement item in electronic or digital media form in exchange for the owner or provider of the counterfeit item delivering the physical item to the company and providing the company with information about their identity so that a new customer relationship can be formed or so that a prior customer relationship can be renewed. One of the benefits of the invention is that this can result in customers who pay a fee for the privilege of forming those new relationships with companies, or who pay a fee to help identify themselves to companies as prior customers who still have an interest in the products in question today. Business operations at the speed of trust become possible when a delivery tracking number, record of shipment from delivery courier 99, evidences third-party possession of physical item 55.

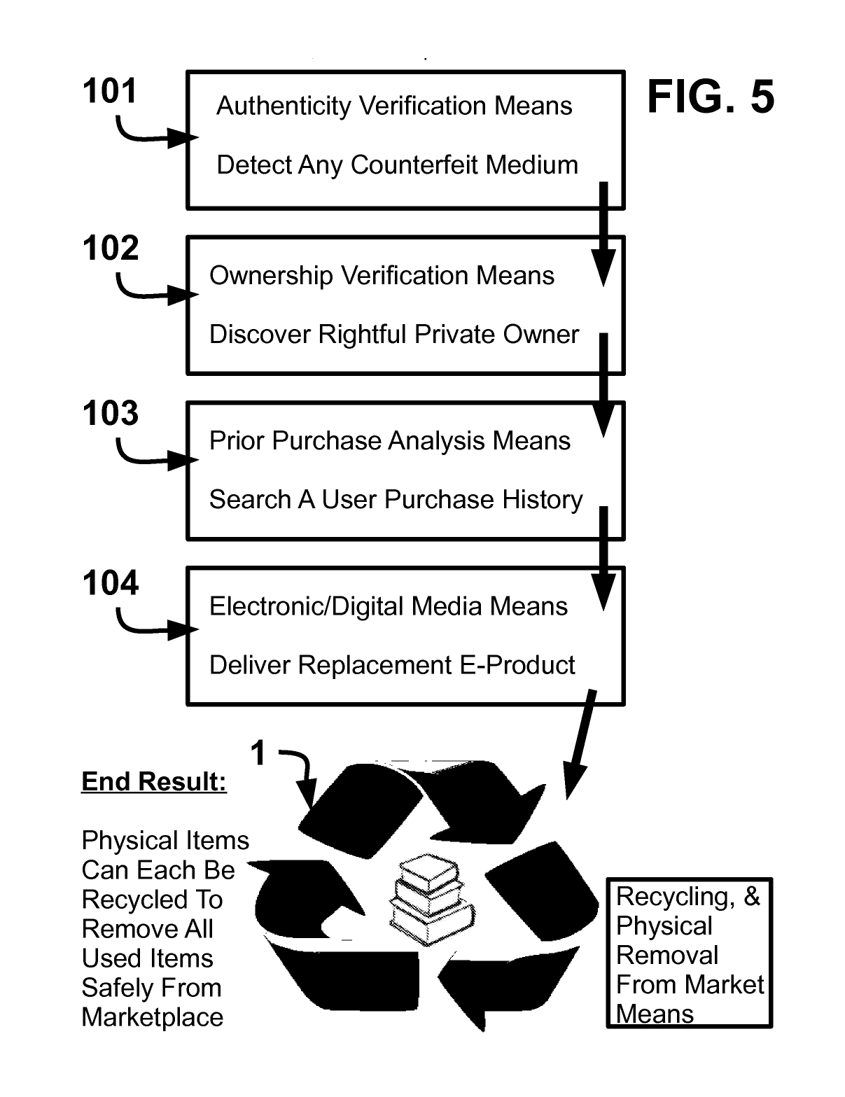

FIG. 5 shows the flow of the sequence of events and the functional means for authenticity verification, which is any mechanism of counterfeit detection so as to determine whether the physical item that is physically received in accordance with the invention is an authentic rather than counterfeit item of merchandise. The sequence of events includes detecting any counterfeit medium, such as paper of poor quality or that lacks a watermark, or a recordable medium such as a memory storage device or disc that lacks certain expected concealed numeric identifiers that would indicate that the medium is the same as the type, variety, brand and quality of medium that are used during authorized manufacturing of the physical item in question. Further steps call for ownership verification, such as by evaluating a purchase receipt and comparing the purchase receipt information to the physical item itself to verify that the receipt corresponds to the physical item, the provider of the physical item proving ownership thereof in some manner in addition to by physically providing the item. Prior purchase analysis searches a database of purchase records, for example. In discovering a rightful private owner whose first-sale property right is being offered in exchange for a replacement electronic or digital media item an important part of the objectives of the invention is realized. Finally, the replacement or substitute item of electronic or digital media form is delivered, the end result of the sequence of events being that physical items can each be recycled to remove all used items safely, and in an economical and environmentally-friendly manner, from a marketplace of pre-owned items.

In some preferred embodiments such as the system depicted in FIG. 6, electronic device 61 is an older, used, out-dated or otherwise less-desirable possibly-antiquated electronic device, such as an old, slow, power-inefficient tablet computer or smart phone, possibly manufactured by a vendor who is unpopular or whose technology platform or content ecosystem did not keep up with the marketplace of evolving consumer demand. When device 61 is recycled or otherwise deconstructed physically, or altered, so that it cannot be resold and so that the intellectual property contained within it is removed or can no longer be conveyed to another owner together with the physical item just by transferring ownership or possession of the physical item, a number of potentially-valuable commercial uses, or re-uses, will be understood to exist by one of skill in the art. Re-use of the raw materials is preferred, so that the materials can be recycled, and re-use of the fully-assembled, bound, item of manufacture is ideal whenever possible, to preserve the past energy investment, carbon footprint impact, and human effort that went into the assembly and transport of the item to bring it to market. However, it is the intent of the present invention that any such re-use of raw materials, or re-use of fully-assembled products, be entirely devoid of the intellectual property that the intellectual property rights-holder previously gave permission for the manufacturer to install or deposit or embed or inscribe within or upon the materials.

Device 62 may be a newer, up-to-date, upgraded, modern, in-demand device such as one that has a faster processor and better power efficiency, higher-quality display, or other features considered superior to those of an older, out-dated device. Device 62 can optionally be a brand-new device that was never before owned by another consumer, and such brand-new device can be delivered as the replacement electronic item as described herein, provided that at least some item of intellectual property is contained on the brand-new device such that the customer is provided with a replacement or substitute for the electronic or digital media item that was physically received previously and that was therefore removed from the used item marketplace in order to be physically recycled or re-used, absent some intellectual property component.

Device 62 may receive a transmission of data directly from a kiosk, such as self-service Kiosk 5, via wireless, Near Field Communication, or physical electronic connector that provides bidirectional data communication ability such as Universal Serial Bus (USB) or similar. Alternatively, device 62 may receive a transmission of data via the Internet or other data communications network such as a wireless public carrier. In certain preferred embodiments of the present invention device 62 will receive a data storage device such as a memory card, or device 62 will be delivered to the user as a brand-new item of merchandise with the intellectual property of interest to the user pre-installed.

It will be understood by one of skill in the art that device 61 and device 62 can be any combination of devices old and new, or first and second, or surrendered and retained, provided that both are able to contain some intellectual property in a useful form that the user can use, read, see, watch or listen to in some fashion. As a result of physically receiving device 61 from a provider thereof, device 62 must serve as a replacement in some manner, or serve as a future storage of such replacement or substitute, if device 62 is not one itself. FIG. 6 also includes means of communication 95, 90, 85, 45 and 40, similar to those discussed in detail previously. Internet 25 and these means of communication enable the components of the system to cooperate and interact as-needed, and to send information to or receive information from computer server 70, as well as other computer servers (not depicted), and to thereby cause data to be stored in or cause data to be retrieved from database 75 and other databases (not depicted) in a manner that is well-known in the prior art.

FIG. 6 also indicates that multiple methods of payment processing for the step of charging a fee or paying a fee are possible. For instance, an ATM machine or other point of sale device 2 could be advantageously coupled to or co-located with the Kiosk 5.

Use of payment cards with magnetic stripes and magnetic stripe reader 3 as depicted is only meant to illustrate one possible method of charging a fee or paying a fee. By virtue of one aspect of the invention, a user interface 15 or equivalent will typically be present and a means of communication, possibly including the Internet 25, or a wireless communication network, will be operable in connection with the invention so that other forms of payment and especially novel forms of payment such as surrendering a property right or receiving a surrendered property right as consideration in lieu of a fee become possible for settlement of the financial aspect of the marketplace transactions that are enabled by the invention. One of skill in the art will recognize surrendering a property right or receiving a property right that has been surrendered is easily accomplished by updating records in databases associated with computer servers, such as database 75 and computer server 70 or some other database and computer server where ownership records are stored and transferred.

The above may be carried out for different types of media, including, CDs, DVDs, books and other print or electronic media stored in tangible form on a storage medium.

A storage medium is defined as a physical object whereby the change in position of some physical portion of the medium results in the data being stored. Such a physical change may be any one of a change in color (ink on a page having a different color), position or share (such as pits in a CD or record), chemical makeup (such as developed film), or position (such as place of a pit on a compact disc).

The customer drops off his or her media at a store, at a kiosk, or at another designated drop-off point.

The media may be mailed to the drop-off point.

The media are then verified, prior to the customer receiving a digital copy of the media. After verification, the media is destroyed or otherwise returned to the publisher for their internal use.

User ownership of a physical work is determined, in an embodiment of the disclosed technology, based on providing the actual version of the work, owned by the user.

This involves providing the book, CD, or the like, which may be verified for authenticity via mechanisms known in the art.

In the case of a book, it may be verified based on the printed ISBN number, paper used, dimensions, physical inspection, and so forth, including combinations of those verification methods mentioned herein.

Similarly, for works such as cassette tapes, CDs, and DVDs, the verification may be based on reading the data burned there-on to compare to the original, the color of the disc, the brand of disc, the case and matching printed material, and/or the label and quality thereof.

Other factors which may be used to determine authenticity are purchase information pertaining to the user, indicative of whether the user had purchased the physical work.

In that regard, the method may further include communication with a third party regarding the purchase information of the user.

Alternatively, user ownership may be confirmed by provision of a receipt from the user evidencing purchase of the physical work.

Another embodiment is directed to a computer system that includes a data storage device, a communications component, and a processing component. The data storage device contains electronic versions of physical works that, when visually displayed, appear the same as the physical works. The communications component is configured to communicate with a user. The processing component is configured to process a request received from the user via the communications component to access an electronic version of a physical work stored in the data storage device. The processing component determines whether the user owns the physical work, and, if so, then provides the user with access to the electronic version of the physical work after confirmation that the original work submitted has been destroyed.

Destruction of the original work may, in another embodiment, take place after distribution of the electronic version of the work to the provider/owner of the work. This procedure allows a publisher to remove from existence physical copies of the work and replace them with digital copies. Consumers benefit because they receive digital copies, or access thereto on-line, and publishers (including the actual publisher, copyright holder, record companies, movie company, or the like) receive data about who is still interested in their works (and may advertise to such people), and decrease the stock of the physical works, which, in some cases, drives up value of the remaining physical copies as there are less physical copies available. Further, it prevents or decreases the likelihood of an owner of a work lending or giving it to a friend, as they can instead recover money from the work.

In yet another embodiment, a computer-readable medium containing executable program instructions may be provided for execution by a computing apparatus. The program instructions, when executed, are configured to provide user access to an electronic version of a physical work based on the user's providing an actual copy of the physical work, which is verified by a processor (person or automated process) that receives the physical work from the user.

Aspects of the disclosed technology may be carried out on a computer device which comprises a processor that controls the overall operation of the computer by executing the device's program instructions which define such operation. The device's program instructions may be stored in a storage device (e.g., magnetic disk, database) and loaded into memory when execution of the console's program instructions is desired. Thus, the device's operation will be defined by the device's program instructions stored in memory and/or storage, and the console will be controlled by a processor executing the console's program instructions. Such a device also includes one or a plurality of input network interfaces for communicating with other devices via a network (e.g., the internet). The device further includes an electrical input interface and one or more output network interfaces for communicating with other devices. Input/output devices, defined as devices which allow for user interaction with a computer (e.g., display, keyboard, mouse, speakers, buttons, etc.) are also used. One skilled in the art will recognize that an implementation of an actual device will contain other components as well.

The process of surrendering a property right or receiving a surrendered property right can be achieved in practice in a number of ways, including by updating a database record to reflect that the first-sale purchase has resulted in the surrender of the property right. It is important that the process utilized be able to indicate that the property right has already been surrendered previously in response to a future attempt to surrender the same property right a second time. It is advantageous to perform a query of the database record that might contain such authoritative information about the status of a prior surrendered first-sale property right by an owner of a physical item before deciding to proceed with delivery of the replacement electronic or digital media item to the user. Failure to verify that the first-sale property right is still owned by the user, or by a third-party, may result in the undesired outcome of additional copies of the electronic or digital media item being released into the marketplace beyond the quantity of supply that was authorized and intended by the manufacturer or intellectual property rights-holder.

Another advantageous optional step in the process of either surrendering a property right or receiving a surrendered property right is to update a database record to reflect and memorialize the identity of the party to whom the first-sale property right was surrendered or transferred. For instance, certain retailers may choose to accept used physical items, together with authenticity verification and confirmation that the first-sale property right of the item's original owner has been surrendered to the retailer, and to sell replacement electronic or digital media items to the first user in addition to reselling the used physical item to a second user. This resale transaction may be facilitated through computer network or other data communications medium, such as a wireless carrier network or an on-premises local area network or a wireless mesh network that enables such trading or reselling of physical items and electronic or digital media replacements as in the case of an auction, industry trade show, or a computer-assisted swap meet.

1. A computer-assisted method, comprising:
physically receiving a physical item manufactured by, or manufactured on behalf of, an intellectual property rights holder; and
delivering an electronic or digital media version of the physical item, or delivering a substitute electronic or digital media product to replace the physical item; and
charging a fee or paying a fee or surrendering a property right or receiving a surrendered property right as consideration in lieu of a fee; and
causing the physical item to be removed from the marketplace of pre-owned physical items by transferring one of physical possession or legal possession of the physical item, or by recycling the physical item so as to remove any intellectual property therefrom, or by altering the physical item, so that the physical item together with the intellectual property contained therein cannot be resold or transferred to another owner without the further consent of the intellectual property rights holder.

2. The method of claim 1 in which the electronic or digital media version of the physical item, or the substitute electronic or digital media product to replace the physical item, is delivered with the help of one of transmitting data via computer network, transmitting data via wireless communications device, transmitting software or other programming instructions, physically connecting a data storage device to a receiving device, downloading or installing from an App store, choosing from an online product catalog, or using near field communication (NFC) technology.

3. The method of claim 1 in which the physical item is one of an optical data storage disc such as a compact disc (CD), digital versatile disc (DVD), Blu-ray disc (BD) or another digital optical data storage disc, or a book, printed magazine, or other literature, or an audio-tape recording or video-tape recording medium, or a magnetic data storage medium such as magnetic tape or magnetic floppy disk or magnetic hard disk, or a persistent digital memory storage device such as a flash RAM device or an electronic device containing flash RAM or another device containing data, or one of an electronic video player or an electronic book reader or a video game device that contains one or both of data and program code stored in an internal data storage together with an integrated display screen, or a smart phone that contains one or both of data and program code stored in an internal data storage together with an integrated display screen, or a creative work of a form that may be eligible for copyright protection, or a creative work of a form that may be eligible for protection as a trade secret, or a creative work of a form that may be eligible for protection under trademark law, or a creative work of a form that may be eligible for protection as a patented invention, or a creative work of a form that is reproducible in three dimensions by computer-controlled machinery such as through the use of a 3-D printer, or an electronic device that receives data from another electronic device through a method of digital communications, or an item that contains an anti-counterfeiting property, device or feature that can be activated, evaluated, or compared against a list of expected values to determine if the item is not an authentic item manufactured by, or manufactured on behalf of, an intellectual property rights holder.

4. a computer-assisted method, comprising:
physically receiving a physical item manufactured by, or manufactured on behalf of, an intellectual property rights holder; and
verifying the authenticity of the physical item using at least one counterfeit detection method; and
delivering an electronic or digital media version of the physical item, or delivering a substitute electronic or digital media product to replace the physical item; and
charging a fee or paying a fee or surrendering a property right or receiving a surrendered property right as consideration in lieu of a fee; and
causing the physical item to be removed from the marketplace of pre-owned physical items by transferring one of physical possession or legal possession of the physical item, or by recycling the physical item so as to remove any intellectual property therefrom, or by altering the physical item, so that the physical item together with the intellectual property contained therein cannot be resold or transferred to another owner without the further consent of the intellectual property rights holder.

5. The method of claim 4 in which the electronic or digital media version of the physical item, or the substitute electronic or digital media product to replace the physical item, is delivered with the help of one of transmitting data via computer network, transmitting data via wireless communications device, transmitting software or other programming instructions, physically connecting a data storage device to a receiving device, downloading or installing from an App store, choosing from an online product catalog, or using near field communication (NFC) technology.

6. The method of claim 4 in which the physical item is one of an optical data storage disc such as a compact disc (CD), digital versatile disc (DVD), Blu-ray disc (BD) or another digital optical data storage disc, or a book, printed magazine, or other literature, or an audio-tape recording or video-tape recording medium, or a magnetic data storage medium such as magnetic tape or magnetic floppy disk or magnetic hard disk, or a persistent digital memory storage device such as a flash RAM device or an electronic device containing flash RAM or another device containing data, or one of an electronic video player or an electronic book reader or a video game device that contains one or both of data and program code stored in an internal data storage together with an integrated display screen, or a smart phone that contains one or both of data and program code stored in an internal data storage together with an integrated display screen, or a creative work of a form that may be eligible for copyright protection, or a creative work of a form that may be eligible for protection as a trade secret, or a creative work of a form that may be eligible for protection under trademark law, or a creative work of a form that may be eligible for protection as a patented invention, or a creative work of a form that is reproducible in three dimensions by computer-controlled machinery such as through the use of a 3-D printer, or an electronic device that receives data from another electronic device through a method of digital communications, or an item that contains an anti-counterfeiting property, device or feature that can be activated, evaluated, or compared against a list of expected values to determine if the item is not an authentic item manufactured by, or manufactured on behalf of, an intellectual property rights holder.

7. a computer-assisted method, comprising:
physically receiving a physical item manufactured by, or manufactured on behalf of, an intellectual property rights holder; and
verifying the authenticity of the physical item using at least one counterfeit detection method; and
confirming that the physical item is of the same type and variety as a physical item purchased by one of the provider of the physical item or a third-party first-sale buyer of the physical item; and
delivering an electronic or digital media version of the physical item, or delivering a substitute electronic or digital media product to replace the physical item; and
charging a fee or paying a fee or surrendering a property right or receiving a surrendered property right as consideration in lieu of a fee; and
causing the physical item to be removed from the marketplace of pre-owned physical items by transferring one of physical possession or legal possession of the physical item, or by recycling the physical item so as to remove any intellectual property therefrom, or by altering the physical item, so that the physical item together with the intellectual property contained therein cannot be resold or transferred to another owner without the further consent of the intellectual property rights holder.

8. The method of claim 7 in which the electronic or digital media version of the physical item, or the substitute electronic or digital media product to replace the physical item, is delivered with the help of one of transmitting data via computer network, transmitting data via wireless communications device, transmitting software or other programming instructions, physically connecting a data storage device to a receiving device, downloading or installing from an App store, choosing from an online product catalog, or using near field communication (NFC) technology.

9. The method of claim 7 in which the physical item is one of an optical data storage disc such as a compact disc (CD), digital versatile disc (DVD), Blu-ray disc (BD) or another digital optical data storage disc, or a book, printed magazine, or other literature, or an audio-tape recording or video-tape recording medium, or a magnetic data storage medium such as magnetic tape or magnetic floppy disk or magnetic hard disk, or a persistent digital memory storage device such as a flash RAM device or an electronic device containing flash RAM or another device containing data, or one of an electronic video player or an electronic book reader or a video game device that contains one or both of data and program code stored in an internal data storage together with an integrated display screen, or a smart phone that contains one or both of data and program code stored in an internal data storage together with an integrated display screen, or a creative work of a form that may be eligible for copyright protection, or a creative work of a form that may be eligible for protection as a trade secret, or a creative work of a form that may be eligible for protection under trademark law, or a creative work of a form that may be eligible for protection as a patented invention, or a creative work of a form that is reproducible in three dimensions by computer-controlled machinery such as through the use of a 3-D printer, or an electronic device that receives data from another electronic device through a method of digital communications, or an item that contains an anti-counterfeiting property, device or feature that can be activated, evaluated, or compared against a list of expected values to determine if the item is not an authentic item manufactured by, or manufactured on behalf of, an intellectual property rights holder.

10. An apparatus, comprising:
a physical receiving means for physical insertion into the apparatus of a physical item manufactured by, or manufactured on behalf of, an intellectual property rights holder; and
an authenticity verification means; and
an ownership verification means; and
a means of searching a purchase history to attempt to locate a prior purchase; and
a means of physical delivery or electronic delivery or digital media delivery of a replacement product.

11. The apparatus of claim 10 in which the physical delivery or electronic delivery or digital media delivery of the replacement product, is accomplished with the help of one of transmitting data via computer network, transmitting data via wireless communications device, transmitting software or other programming instructions, physically connecting a data storage device to a receiving device, downloading or installing from an App store, choosing from an online product catalog, or using near field communication (NFC) technology.

12. The apparatus of claim 10 in which the physical item is one of an optical data storage disc such as a compact disc (CD), digital versatile disc (DVD), Blu-ray disc (BD) or another digital optical data storage disc, or a book, printed magazine, or other literature, or an audio-tape recording or video-tape recording medium, or a magnetic data storage medium such as magnetic tape or magnetic floppy disk or magnetic hard disk, or a persistent digital memory storage device such as a flash RAM device or an electronic device containing flash RAM or another device containing data, or one of an electronic video player or an electronic book reader or a video game device that contains one or both of data and program code stored in an internal data storage together with an integrated display screen, or a smart phone that contains one or both of data and program code stored in an internal data storage together with an integrated display screen, or a creative work of a form that may be eligible for copyright protection, or a creative work of a form that may be eligible for protection as a trade secret, or a creative work of a form that may be eligible for protection under trademark law, or a creative work of a form that may be eligible for protection as a patented invention, or a creative work of a form that is reproducible in three dimensions by computer-controlled machinery such as through the use of a 3-D printer, or an electronic device that receives data from another electronic device through a method of digital communications, or an item that contains an anti-counterfeiting property, device or feature that can be activated, evaluated, or compared against a list of expected values to determine if the item is not an authentic item manufactured by, or manufactured on behalf of, an intellectual property rights holder.

13. A system, comprising:
a means of physically receiving a physical item manufactured by, or manufactured on behalf of, an intellectual property rights holder; and
a means of delivery of an electronic or digital media version of the physical item, or a means of delivery of a substitute electronic or digital media product to replace the physical item; and
a means of charging a fee or a means of paying a fee or a means of surrendering a property right or a means of receiving a surrendered property right as consideration in lieu of a fee; and
a means of causing the physical item to be removed from the marketplace of pre-owned physical items by transferring one of physical possession or legal possession of the physical item, or by recycling the physical item so as to remove any intellectual property therefrom, or by altering the physical item, so that the physical item together with the intellectual property contained therein cannot be resold or transferred to another owner without the further consent of the intellectual property rights holder.

14. The system of claim 13 in which the electronic or digital media version of the physical item, or the substitute electronic or digital media product to replace the physical item, is delivered using a means of one of transmitting data via computer network, transmitting data via wireless communications device, transmitting software or other programming instructions, physically connecting a data storage device to a receiving device, downloading or installing from an App store, choosing from an online product catalog, or using near field communication (NFC) technology.

15. The system of claim 13 in which the physical item is one of an optical data storage disc such as a compact disc (CD), digital versatile disc (DVD), Blu-ray disc (BD) or another digital optical data storage disc, or a book, printed magazine, or other literature, or an audio-tape recording or video-tape recording medium, or a magnetic data storage medium such as magnetic tape or magnetic floppy disk or magnetic hard disk, or a persistent digital memory storage device such as a flash RAM device or an electronic device containing flash RAM or another device containing data, or one of an electronic video player or an electronic book reader or a video game device that contains one or both of data and program code stored in an internal data storage together with an integrated display screen, or a smart phone that contains one or both of data and program code stored in an internal data storage together with an integrated display screen, or a creative work of a form that may be eligible for copyright protection, or a creative work of a form that may be eligible for protection as a trade secret, or a creative work of a form that may be eligible for protection under trademark law, or a creative work of a form that may be eligible for protection as a patented invention, or a creative work of a form that is reproducible in three dimensions by computer-controlled machinery such as through the use of a 3-D printer, or an electronic device that receives data from another electronic device through a method of digital communications, or an item that contains an anti-counterfeiting property, device or feature that can be activated, evaluated, or compared against a list of expected values to determine if the item is not an authentic item manufactured by, or manufactured on behalf of, an intellectual property rights holder.

16. a system, comprising:
a means of physically receiving a physical item manufactured by, or manufactured on behalf of, an intellectual property rights holder; and
a means of verifying the authenticity of the physical item using at least one counterfeit detection method; and
a means of delivering an electronic or digital media version of the physical item, or a means of delivering a substitute electronic or digital media product to replace the physical item; and
a means of charging a fee or a means of paying a fee or a means of surrendering a property right or a means of receiving a surrendered property right as consideration in lieu of a fee; and
a means of causing the physical item to be removed from the marketplace of pre-owned physical items by transferring one of physical possession or legal possession of the physical item, or by recycling the physical item so as to remove any intellectual property therefrom, or by altering the physical item, so that the physical item together with the intellectual property contained therein cannot be resold or transferred to another owner without the further consent of the intellectual property rights holder.

17. The system of claim 16 in which the electronic or digital media version of the physical item, or the substitute electronic or digital media product to replace the physical item, is delivered using a means of one of transmitting data via computer network, transmitting data via wireless communications device, transmitting software or other programming instructions, physically connecting a data storage device to a receiving device, downloading or installing from an App store, choosing from an online product catalog, or using near field communication (NFC) technology.

18. The system of claim 16 in which the physical item is one of an optical data storage disc such as a compact disc (CD), digital versatile disc (DVD), Blu-ray disc (BD) or another digital optical data storage disc, or a book, printed magazine, or other literature, or an audio-tape recording or video-tape recording medium, or a magnetic data storage medium such as magnetic tape or magnetic floppy disk or magnetic hard disk, or a persistent digital memory storage device such as a flash RAM device or an electronic device containing flash RAM or another device containing data, or one of an electronic video player or an electronic book reader or a video game device that contains one or both of data and program code stored in an internal data storage together with an integrated display screen, or a smart phone that contains one or both of data and program code stored in an internal data storage together with an integrated display screen, or a creative work of a form that may be eligible for copyright protection, or a creative work of a form that may be eligible for protection as a trade secret, or a creative work of a form that may be eligible for protection under trademark law, or a creative work of a form that may be eligible for protection as a patented invention, or a creative work of a form that is reproducible in three dimensions by computer-controlled machinery such as through the use of a 3-D printer, or an electronic device that receives data from another electronic device through a method of digital communications, or an item that contains an anti-counterfeiting property, device or feature that can be activated, evaluated, or compared against a list of expected values to determine if the item is not an authentic item manufactured by, or manufactured on behalf of, an intellectual property rights holder.

19. a system, comprising:
a means of physically receiving a physical item manufactured by, or manufactured on behalf of, an intellectual property rights holder; and
a means of verifying the authenticity of the physical item using at least one counterfeit detection method; and
a means of confirming that the physical item is of the same type and variety as a physical item purchased by one of the provider of the physical item or a third-party first-sale buyer of the physical item; and
a means of delivering an electronic or digital media version of the physical item, or a means of delivering a substitute electronic or digital media product to replace the physical item; and
a means of charging a fee or a means of paying a fee or a means of surrendering a property right or a means of receiving a surrendered property right as consideration in lieu of a fee; and
a means of causing the physical item to be removed from the marketplace of pre-owned physical items by transferring one of physical possession or legal possession of the physical item, or by recycling the physical item so as to remove any intellectual property therefrom, or by altering the physical item, so that the physical item together with the intellectual property contained therein cannot be resold or transferred to another owner without the further consent of the intellectual property rights holder.

20. The system of claim 19 in which the electronic or digital media version of the physical item, or the substitute electronic or digital media product to replace the physical item, is delivered using a means of one of transmitting data via computer network, transmitting data via wireless communications device, transmitting software or other programming instructions, physically connecting a data storage device to a receiving device, downloading or installing from an App store, choosing from an online product catalog, or using near field communication (NFC) technology.

21. The system of claim 19 in which the physical item is one of an optical data storage disc such as a compact disc (CD), digital versatile disc (DVD), Blu-ray disc (BD) or another digital optical data storage disc, or a book, printed magazine, or other literature, or an audio-tape recording or video-tape recording medium, or a magnetic data storage medium such as magnetic tape or magnetic floppy disk or magnetic hard disk, or a persistent digital memory storage device such as a flash RAM device or an electronic device containing flash RAM or another device containing data, or one of an electronic video player or an electronic book reader or a video game device that contains one or both of data and program code stored in an internal data storage together with an integrated display screen, or a smart phone that contains one or both of data and program code stored in an internal data storage together with an integrated display screen, or a creative work of a form that may be eligible for copyright protection, or a creative work of a form that may be eligible for protection as a trade secret, or a creative work of a form that may be eligible for protection under trademark law, or a creative work of a form that may be eligible for protection as a patented invention, or a creative work of a form that is reproducible in three dimensions by computer-controlled machinery such as through the use of a 3-D printer, or an electronic device that receives data from another electronic device through a method of digital communications, or an item that contains an anti-counterfeiting property, device or feature that can be activated, evaluated, or compared against a list of expected values to determine if the item is not an authentic item manufactured by, or manufactured on behalf of, an intellectual property rights holder.

22. a computer-assisted method, comprising:
physically receiving a physical item manufactured by, or manufactured on behalf of, an intellectual property rights holder; and
verifying the authenticity of the physical item using at least one counterfeit detection method; and
confirming that the physical item is of the same type and variety as a physical item purchased by one of the provider of the physical item or a third-party first-sale buyer of the physical item; and
offering an electronic or digital media version of the physical item, or offering a substitute electronic or digital media product to replace the physical item, to the provider of the physical item; and
communicating to the provider of the physical item a certification, or evidence, of a property right; and
receiving information about the identity of the provider of the physical item.

23. The method of claim 22 in which the information about the identity of the provider of the physical item is used to send an advertisement to the provider or to an electronic device used by the provider.

24. The method of claim 22 in which information about the identity of the provider of the physical item or information about the physical item is used in statistical, economic, demographic or trend analysis to display a report or to make a decision.
